(19) United States
(12) Patent Application Publication
(10) Pub. No.: US 2023/0065267 A1
(43) Pub. Date: Mar. 2, 2023

(54) COMPOSITE PARTS WITH IMPROVED MODULUS

(71) Applicant: Owens Corning Intellectual Capital, LLC, Toledo, OH (US)

(72) Inventors: James Priest, Frazeysburg, OH (US); David Hartman, Granville, OH (US); Michelle Korwin-Edson, Granville, OH (US); Mala Nagarajan, New Albany, OH (US)

(21) Appl. No.: 17/796,327

(22) PCT Filed: Feb. 25, 2021
(86) PCT No.: PCT/US21/19571

§ 371 Date: Jul. 29, 2022

Related U.S. Application Data
(60) Provisional application No. 62/981,760, filed on Feb. 26, 2020.

(51) Int. Cl. B29C 70/20; B29C 70/52; B29C 70/88; B29C 70/00

(52) U.S. Cl. CPC B29C 70/20; B29C 70/521; B29C 70/882; B29C 70/003; B29C 2791/003; B29K 2063/00

(57) ABSTRACT

A high modulus composite part is disclosed comprising a polymer resin; and a plurality of high-performance unidirectional glass fibers. The high-performance unidirectional glass fibers have an elastic modulus of at least 89 GPa and a tensile strength of at least 4,000 MPa, according to ASTM D2343-09. The composite part comprises a fiber weight fraction (FWF) of no more than 88% and an elastic modulus of at least 60 GPa, according to ASTM D7205.

### CROSS-REFERENCE TO RELATED APPLICATIONS

This application claims priority to and all benefit of U.S. Provisional Patent Application No. 62/981,760 , filed on Feb. 26, 2020, the entire disclosure of which is fully incorporated herein by reference.

### FIELD OF THE INVENTION

The invention generally relates to composite parts and, more particularly, to high modulus composite parts, such as reinforcing bars (“rebar”) for concrete, composed of high-performance glass fibers.

### BACKGROUND OF THE INVENTION

Concrete is one of the most common building materials. It is used in a wide variety of structures such as bridges, walls, floors, building supports, roadways, and runways among many others. Concrete has excellent compressive strength but has very poor tensile strength. As a result, it is almost always necessary to reinforce a concrete structure if the structure will be exposed to tensile stresses such as those generated by a bending load. Conventionally, this reinforcement is provided by incorporating metal, usually in the form of steel bars, into the concrete to improve the tensile strength of the concrete structure.

There are a number of drawbacks to steel reinforcement in concrete construction, at least in certain applications. For instance, steel reinforcements corrode over time when exposed to water and salts. As steel corrodes, it tends to expand due to the formation of rust layers, which causes cracking in the concrete and decay of the concrete structure. Therefore, attempts have been made to replace steel bars with bars that are at least partly made of non-metallic materials. For instance, pultruded composite reinforcements have been developed that include a thermoset resin into which continuous fibers are embedded.

Fiber-reinforced composites, such as composite rebar, typically include a fibrous reinforcing material (e.g., glass, polymeric, or carbon fibers) embedded in a resin matrix (e.g., a polymer such as an unsaturated polyester or epoxy vinyl ester). The fibrous reinforcing material typically includes both yarns or tows (each of which include a large number of fibers or filaments) and one or more mats or webs of fibers.

Such fiber-reinforced composites are often produced by a pultrusion process and have a linear or uniform profile. Conventional pultrusion processes involve drawing a bundle of reinforcing material from a source thereof, wetting and impregnating the fibers (preferably with a thermo-settable polymer resin) by passing the reinforcing material through a resin bath in an open tank, pulling the resin-wetted and impregnated bundle through a shaping die to align the fiber bundle and to manipulate it into the proper cross sectional configuration, and curing the resin in a mold while maintaining tension on the filaments.

Some fiber-reinforced composites, such as rebar, require corrosion resistance and are traditionally manufactured using corrosion-resistant glass fibers (or E-CR glass fibers). E-CR-type glass fibers are a family of aluminosilicate glasses exhibiting high water-, acid-, and alkali-resistance. E-CR-glasses are understood to be boron-free, modified E-glass compositions with higher acid corrosion resistance comprising calcium aluminosilicates and approximately 1% alkali oxides. E-CR-glasses are typically used where strength, electrical conductivity and acid corrosion resistance are necessary.

One example of boron-free, E-CR glass fibers are sold under the trademark ADVANTEX® (Owens Coming, Toledo, Ohio, USA). Such boron-free fibers, disclosed in U.S. Pat. No. 5,789,329 and incorporated herein by reference in its entirety, offer a significant improvement in operating temperatures over boron-containing E-glass. E-CR glass fibers fall under the ASTM definition for E-glass fibers for use in general-use applications.

In order for composite parts to be a viable replacement for the current steel solutions, the composite parts must exhibit an increased modulus and excellent alkaline corrosion resistance.

Recently, a category of glass fibers, known as high-performance glass fibers, have been developed with a focus on improving the mechanical properties of the glass. High-performance glass fibers possess higher strength and stiffness, compared to traditional E-glass fibers. Elastic modulus (interchangeable with “Young's modulus”) is a measure of the fiber stiffness, defining a relationship between the stress applied to a material and the strain produced by the same material. A stiff material has a high elastic modulus and changes its shape only slightly under elastic loads. A flexible material has a low elastic modulus and changes its shape considerably. In particular, for some products, stiffness is crucial for modeling and performance.

Although high-performance glasses are generally known, such property improvements have come at the cost of corrosion resistance performance. Traditional high-performance glasses use fluxes to reduce melting point and improve their forming window or delta T (“ΔT”). These fluxes, such as lithium, boron, and fluorine, are known to negatively impact alkaline corrosion performance. As a result, use of traditional high-performance glasses in rebar applications has been limited. In fact, there has yet to be a high-performance-type glass that is useful in fiber-reinforced composites requiring corrosion resistance. Thus, it is desirable to develop fiber-reinforced composites utilizing high-performance glass while maintaining alkali corrosion resistance to improve the physical properties of composite parts, such as rebar and ladder rails.

### SUMMARY OF THE INVENTION

The foregoing and other objects, features, and advantages of the invention will appear more fully hereinafter from a consideration of the detailed description that follows.

Various aspects of the present inventive concepts are directed to a high modulus composite part comprising a polymer resin and a plurality of high-performance unidirectional glass fibers. The high-performance unidirectional glass fibers have an elastic modulus of at least 89 GPa and a tensile strength of at least 4,500 MPa, according to ASTM D2343-09. The composite part comprises a fiber weight fraction (FWF) of no more than 88% and an elastic modulus of at least 60 GPa, as measured in accordance with ASTM D7205.

In some exemplary embodiments, the polymer resin is selected from the group consisting of urethane, acrylic, polyester, vinyl ester, and epoxy.

The high modulus composite part may comprise rebar, railings, poles, pipes, cross-arms, infrastructure, cables, telecom applications, ladder rails, and the like.

In some exemplary embodiments, the high modulus composite comprises glass fibers that are formed from a composition that is substantially free of B₂O₃ and fluorine. In these or other embodiments, the composition is free of Li₂O.

The high-performance glass fibers have a tensile strength of at least 4,800 MPa and an elastic modulus of at least 90 GPa. In some exemplary embodiments, the high-performance glass fibers have a specific modulus (i.e. modulus normalized by density) from about 32.0 MJ/kg to about 37.0 MJ/kg.

The high modulus composite part formed using such high-performance glass fibers comprises an elastic modulus of at least 60 GPa, according to ASTM D7205, and may comprise one or more of a flexural modulus of at least 50 GPa and a tensile modulus of at least 50 GPa, according to ASTM D7205, depending on fiber content and density.

Various aspects of the present inventive concepts are further directed to a process for forming a high modulus composite part comprising drawing a bundle of high-performance unidirectional glass fibers from an input source. The fibers comprise an elastic modulus of at least 89 GPa and a tensile strength of at least 4,500 MPa, according to ASTM D2343-09. The method further includes passing the bundle through a bath of polymer resin material, forming resin-coated bundle; pulling the resin-coated bundle through a shaping die; and curing the resin-coated bundle, forming a high modulus composite part comprising a fiber weight fraction (FWF) of no more than 88% and an elastic modulus of at least 60 GPa according to ASTM D7205.

In some exemplary embodiments, the polymer resin is selected from the group consisting of polyester, vinyl ester, and epoxy.

In some exemplary embodiments, the high-performance glass fibers are formed from a composition that is substantially free of B₂O₃ and fluorine. In these or other embodiments, the composition may be free of Li₂O.

In some exemplary embodiments, the high-performance glass fibers have a tensile strength of at least 4,800 MPa and an elastic modulus of at least 90 GPa.

In some exemplary embodiments, the high-performance glass fibers have a specific modulus from about 32.0 MJ/kg to about 37.0 MJ/kg.

The high modulus composite part formed using such high-performance glass fibers comprises an elastic modulus of at least 60 GPa and may comprise one or more of a flexural modulus of at least 50 GPa and a tensile modulus of at least 50 GPa.

### BRIEF DESCRIPTION OF THE FIGURES

The general inventive concepts, as well as embodiments and advantages thereof, are described below in greater detail, by way of example, with reference to the drawings in which:

FIGS. 1A and 1B are diagrams of a pultrusion line for making composite rods, according to an exemplary embodiment.

FIG. 2 graphically illustrates the effective elastic modulus of rebar vs. fiber weight fraction of composites formed with conventional E-CR glass and high-performance glass.

FIGS. 3A and 3B illustrate the flexural modulus for composite parts formed using conventional E-CR glass and high-performance glass in both unsaturated polyester and polyurethane resin.

FIGS. 4A and 4B illustrate the flexural strength for composite parts formed using conventional E-CR glass and high-performance glass in both unsaturated polyester and polyurethane resin.

FIGS. 5A and 5B illustrate the tensile modulus for composite parts formed using conventional E-CR glass and high-performance glass in both unsaturated polyester and polyurethane resin.

FIGS. 6A and 6B illustrate the interlaminar shear strength for composite parts formed using conventional E-CR glass and high-performance glass in both unsaturated polyester and polyurethane resin.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts.

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

The present disclosure relates to a high modulus fiber-reinforced composite part (“high modulus composite”) comprising a polymer matrix and a corrosion-resistant, high-performance glass for improved performance and cost efficiency, as well as systems for and methods of producing such high modulus composite. The high modulus composite achieves a modulus of at least 60 GPa, as measured in accordance with ASTM D7205, with no greater than 85% fiber weight fraction (“FWF”) glass loading.

The high modulus composite is formed by a pultrusion process (described below) in which continuous high-performance glass fibers are fed through a die to form a rod, bar, or other linear reinforcing member having a desired cross-section. The high modulus composite may comprise any type of pultruded composite known in the art, including, but not limited to, rebar, railings, poles, pipes, cross-arms, infrastructure, cables, telecom applications, ladder rails, and the like.

Typically, the reinforcing member will be in the shape of a rod having a circular cross-section. These rods can be cut to any desired length. In some exemplary embodiments, the rods can be shaped (e.g., bent) and/or joined with other rods to form more complex shapes and structures.

The high modulus composite includes an input of continuous high-performance glass fibers. By “high-performance glass fiber” it is meant that the fiberglass is corrosion-resistant, comprises a tensile strength of at least 4,000 MPa, and in some cases at least 4,500 MPa) according to ASTM D2343-09, and an elastic modulus of at least 89 GPa. The elastic modulus of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965.

Conventional high-performance glasses use fluxes, such as lithium, boron, and fluorine, which are known to negatively impact corrosion resistance. In contrast, the present high-performance glass composition includes low levels or is at least substantially free of B₂O₃, Li₂O, and fluorine. As used herein, substantially free of B₂O₃, Li₂O, and fluorine means that the sum of the amounts of B₂O₃, Li₂O, and fluorine present is less than 1.0% by weight of the composition. The sum of the amounts of B₂O₃, Li₂O, and fluorine present may be less than about 0.5% by weight of the composition, including less than about 0.2% by weight, less than about 0.1% by weight, and less than about 0.05% by weight. However, in some exemplary embodiments, low levels of lithium may be included, such as 0.1 to 2.0% by weight.

It has been surprisingly discovered that high-performance glass fiber inputs may be developed that comprise an elastic modulus of at least 89 GPa and corrosion resistance (exhibiting less than 12% gravimetric mass loss after 24-hr soak in corrosive media or greater than 75% strength retention after 32-day soak in corrosive media) sufficient for use in applications that traditionally utilize lower performing, traditional E-CR glass fibers, such as composite rebar.

The fiber tensile strength is also referred herein simply as “strength.” In some exemplary embodiments, the tensile strength is measured on pristine fibers (i.e., unsized and untouched laboratory produced fibers) using an Instron tensile testing apparatus according to ASTM D2343-09. Exemplary glass fibers may have a fiber tensile strength of at least 4,500 MPa, at least 4,800 MPa, at least 4,900 MPa, at least 4,950 MPa, at least 5,000 MPa, at least 5,100 MPa, at least 5,150 MPa, and at least 5,200 MPa. In some exemplary embodiments, the glass fibers formed from the above described composition have a fiber tensile strength of from about 3,500 to about 5,500 MPa, including about 4,000 MPa to about 5,300, about 4,600 to about 5,250 MPa. Advantageously, high-performance glass fibers having tensile strengths of at least 4,800 MPa, including at least 4,900 MPa, and at least 5,000 MPa.

The high-performance glass fibers may have an elastic modulus of at least about 85 GPa, including at least about 88 GPa, at least about 88.5 GPa, at least about 89 GPa, and at least about 89.5 GPa. In some exemplary embodiments, the exemplary glass fibers have an elastic modulus of between about 85 GPa and about 95 GPa, including between about 87 GPa and about 92 GPa, and between about 88 GPa and about 91 GPa. As mentioned above, the elastic modulus of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965.

In one or more exemplary embodiments, the high-performance glass fibers have a moderately high elastic modulus of between about 90 GPa and about 92 GPa. In some exemplary embodiments, the high-performance glass fibers have an elastic modulus of at least 90.5 GPa, such as at least 90.6 GPa, at least 90.8 GPa, at least 91.0 GPa, at least 91.2 GPa. In some exemplary embodiments, the high-performance glass fibers have an elastic modulus of between about 90.2 GPa and about 92 GPa, including between about 90.5 GPa and about 91.9 GPa, and between about 90.7 GPa and about 91.8 GPa.

The modulus may then be used to determine the specific modulus. It is desirable to have as high of a specific modulus as possible to achieve a lightweight composite material that adds stiffness to the final article. Specific modulus is important in applications where stiffness of the product is an important parameter, such as in reinforcing bars for concrete. As used herein, the specific modulus is calculated by the following equation:

Specific Modulus (MJ/kg)=Modulus (GPa)/Density(kg/cubic meter)

The high-performance glass fibers may have a specific modulus from about 32.0 MJ/kg to about 37.0 MJ/kg, including about 33 MJ/kg to about 36 MJ/kg, and about 33.5 MJ/kg to about 35.5 MJ/kg.

The density may be measured by any method known and commonly accepted in the art, such as the Archimedes method (ASTM C693-93(2008)) on unannealed bulk glass. The glass fibers have a density of from about 2.0 to about 3.0 g/cc. In other exemplary embodiments, the glass fibers have a density of from about 2.3 to about 2.8 g/cc, including from about 2.4 to about 2.7 g/cc, and about 2.5 to about 2.65 g/cc.

Additionally, the high-performance glass fibers have improved alkaline corrosion resistance. The corrosion resistance may be quantified by any method known and commonly accepted in the art, such as by measuring the gravimetric weight loss (%) of the glass fibers after a 24-hr soak in one of the following: pH 12.88 NaOH, 10% HCl, or 10% H₂SO₄. Glass fibers with less than 12% gravimetric mass loss after the 24-hr soak are considered to possess improved corrosion resistance. Corrosion resistance may also be quantified in terms of the percent strength retention (%) after a 32-day soak in one of the following: pH 12.88 NaOH, 10% HCl, or 10% H₂SO₄. The glass fibers retaining at least 75% dry strand strength after a 32-day soak are considered corrosion resistant.

In some exemplary embodiments, a diameter of the input high-performance glass fibers is within the range of 13 μm to 35 μm. In some exemplary embodiments, a diameter of the input high-performance glass fibers is within the range of 17 μm to 32 μm. The input material (e.g., glass fibers, carbon fibers) will typically have a sizing applied thereto that is compatible with the resin matrix being used to form the composite rod.

In some exemplary embodiments, the glass content will be no greater than 88 wt. % of the pultruded rod. In some exemplary embodiments, the glass or hybrid fiber content will be within the range of 50 wt. % to 88 wt. % of the pultruded rod. In some exemplary embodiments, the glass content will be within the range of 55 wt. % to 86 wt. %, including between 58 wt. % to 85 wt. %, and between 60 wt. % and 80 wt. %. In some exemplary embodiments, the glass content will be in the range of 80 wt. % to 86 wt. % of the pultruded part.

### Glass Compositions

### Exemplary Glass Composition I

The high-performance glass composition may include about 55.0 to about 65.0% by weight SiO₂, about 17.0 to about 27.0% by weight Al₂O₃, about 8.0 to about 15.0% by weight MgO, about 7.0 to about 12.0% by weight CaO, about 0.0 to about 1.0% by weight Na₂O, 0 to about 2.0% by weight TiO₂, 0 to about 2.0% by weight Fe₂O₃, and no more than 0.5% by weight Li₂O.

In some exemplary embodiments, the glass composition may comprise about 57.0 to about 62.0% by weight SiO₂, about 19.0 to about 25.0% by weight Al₂O₃, about 10.5 to about 14.0% by weight MgO, about 7.5 to about 10.0% by weight CaO, about 0.0 to about 0.5% by weight Na₂O, 0.2 to about 1.5% by weight TiO₂, 0 to about 1.0% by weight Fe₂O₃, and no more than 0.1% by weight Li₂O. In some exemplary embodiments, the glass composition includes an Al₂O₃/MgO ratio less than 2 and an MgO/CaO ratio of at least 1.25.

In some exemplary embodiments, the glass composition may comprise about 57.5 to about 60.0% by weight SiO₂, about 19.5 to about 21.0% by weight Al₂O₃, about 11.0 to about 13.0% by weight MgO, about 8.0 to about 9.5% by weight CaO, about 0.02 to about 0.25% by weight Na₂O, 0.5 to about 1.2% by weight TiO₂, 0 to about 0.5% by weight Fe₂O₃, and no more than 0.05% by weight Li₂O. In some exemplary embodiments, the glass composition includes an Al₂O₃/MgO no greater than 1.8 and an MgO/CaO ratio of at least 1.25.

The glass composition includes at least 55% by weight, but no greater than 65% by weight SiO₂. Including greater than 65% by weight SiO₂ causes the viscosity of the glass composition to increase to an unfavorable level. Moreover, including less than 55% by weight SiO₂ increases the liquidus temperature and the crystallization tendency. In some exemplary embodiments, the glass composition includes at least 57% by weight SiO₂, including at least 57.5% by weight, at least 58% by weight, at least 58.5% by weight, and at least 59% by weight. In some exemplary embodiments, the glass composition includes no greater than 60.5% by weight SiO₂, including no greater than 60.3% by weight, no greater than 60.2% by weight, no greater than 60% by weight, no greater than 59.8% by weight, and no greater than 59.5% by weight.

To achieve both the desired mechanical and fiberizing properties, one important aspect of the glass composition is having an Al₂O₃ concentration of at least 19.0% by weight and no greater than 27% by weight. Including greater than 27% by weight Al₂O₃ causes the glass liquidus to increase to a level above the fiberizing temperature, which results in a negative ΔT. Including less than 19% by weight Al₂O₃ forms a glass fiber with an unfavorably low modulus. In some exemplary embodiments, the glass composition includes at least 19.5% by weight Al₂O₃, including at least 19.7% by weight, at least 20% by weight, at least 20.25% by weight, and at least 20.5% by weight.

The glass composition advantageously includes at least 8.0% by weight and no greater than 15% by weight MgO. Including greater than 15% by weight MgO will cause the liquidus temperature to increase, which also increases the glass's crystallization tendency. Including less than 8.0% by weight forms a glass fiber with an unfavorably low modulus is substituted by CaO and an unfavorable increase in viscosity if substituted with SiO₂. In some exemplary embodiments, the glass composition includes at least 9.5% by weight MgO, including at least 10% by weight, at least 10.5% by weight, at least 11% by weight, at least 11.10% by weight, at least 11.25% by weight, at least 12.5% by weight, and at least 13% by weight MgO.

Another important aspect of the subject glass composition that makes it possible to achieve the desired mechanical and fiberizing properties, is having an Al₂O₃/MgO ratio of no greater than 2.0. It has been discovered that glass fibers having compositions with otherwise similar compositional ranges, but with Al₂O₃/MgO ratios greater than 2.0, are unable to achieve tensile strengths of at least 4,800 MPa, according to ASTM D2343-09. In certain exemplary aspects, the combination of an Al₂O₃ concentration of at least 19% by weight and an Al₂O₃/MgO ratio of no greater than 2, such as no greater than 1.9, and no greater than 1.85, makes it possible to obtain glass fibers with desirable fiberizing properties and tensile strengths of at least 4,800 MPa, according to ASTM D2343-09.

The glass composition advantageously includes at least 7.0% by weight and no greater than 12% by weight CaO. Including greater than 12% by weight CaO forms a glass with a low elastic modulus. Including less than 7% by weight will either unfavorably increase the liquidus temperature or viscosity depending on what the CaO is substituted with. In some exemplary embodiments, the glass composition includes at least 8.0% by weight CaO, including at least 8.3% by weight, at least 8.5% by weight, at least 8.7% by weight, and at least 9.0% by weight.

In some exemplary embodiments, the combined amounts of SiO₂, Al₂O₃, MgO, and CaO is at least 98% by weight, or at least 99% by weight, and no greater than 99.5% by weight. In some exemplary embodiments, the combined amounts of SiO₂, Al₂O₃, MgO, and CaO is between 98.3% by weight and 99.5% by weight, including between 98.5% by weight and 99.4% by weight and 98.7% by weight and 99.3% by weight.

In some exemplary embodiments, the total concentration of MgO and CaO is at least 10% by weight and no greater than 22% by weight, including between 13% by weight and 21.8% by weight and between 14% by weight and 21.5% by weight. In some exemplary embodiments, the total concentration of MgO and CaO is at least 20% by weight.

The glass composition may include up to about 2.0% by weight TiO₂. In some exemplary embodiments, the glass composition includes about 0.01% by weight to about 1.0% by weight TiO₂, including about 0.1% by weight to about 0.8% by weight and about 0.2 to about 0.7% by weight.

The glass composition may include up to about 2.0% by weight Fe₂O₃. In some exemplary embodiments, the glass composition includes about 0.01% by weight to about 1.0% by weight Fe₂O₃, including about 0.05% by weight to about 0.6% by weight and about 0.1 to about 0.5% by weight.

In some exemplary embodiments, the glass composition includes less than 2.0% by weight of the alkali metal oxides Na₂O and K₂O, including between 0 and 1.5% by weight. The glass composition may advantageously include both Na₂O and K₂O in an amount greater than 0.01% by weight of each oxide. In some exemplary embodiments, the glass composition includes about 0 to about 1% by weight Na₂O, including about 0.01 to about 0.5% by weight, about 0.03 to about 0.3% by weight, and 0.04 to about 0.1% by weight. In some exemplary embodiments, the glass composition includes about 0 to about 1% by weight K₂O, including about 0.01 to about 0.5% by weight, about 0.03 to about 0.3% by weight, and 0.04 to about 0.1% by weight.

### Exemplary Glass Composition II

In some exemplary embodiments, the high-performance glass fibers are formed from a glass composition that includes at least 57% by weight, but no greater than 62% by weight SiO₂. In some exemplary embodiments, the glass composition includes at least or greater than 57.25% by weight SiO₂, including at least or greater than 57.5% by weight, at least or greater than 58% by weight, and at least or greater than 58.25% by weight. In some exemplary embodiments, the glass composition includes no greater than 60.5% by weight SiO₂, including no greater than 60.3% by weight, no greater than 60.2% by weight, no greater than 60% by weight, no greater than 59.8% by weight, and no greater than 59.5% by weight. In some exemplary embodiments, the glass composition comprises 57.5% by weight to less than 59% by weight SiO₂.

In these or other exemplary embodiments, to achieve both the desired mechanical and fiberizing properties, one important aspect of the glass composition is having an Al₂O₃ concentration of at least 19.0% by weight and no greater than 25.0% by weight. Including less than 19.0% by weight Al₂O₃ contributes to the formation of a glass fiber with an unfavorably low modulus. In some exemplary embodiments, the glass composition includes at least 19.5% by weight Al₂O₃, including at least 19.7% by weight, at least 20.0% by weight, at least 20.05% by weight, and at least 20.10% by weight. In some exemplary embodiments, the glass composition includes no greater than 22.0% by weight Al₂O₃, including no greater than 21.8% by weight, no greater than 21.6% by weight, no greater than 21.2% by weight, no greater than 21.1% by weight, and no greater than 21% by weight. In some exemplary embodiments, the glass composition comprises 20.0% by weight to less than 21% by weight Al₂O₃. Including higher levels of Al₂O₃ increases the crystallization tendency.

The glass composition advantageously includes at least 8.0% by weight and no greater than 15% by weight MgO. Including greater than 15% by weight MgO will cause the liquidus temperature to increase, which also increases the glass's crystallization tendency. Including less than 8.0% by weight forms a glass fiber with an unfavorably low modulus if substituted by CaO and an unfavorable increase in viscosity if substituted with SiO₂. In some exemplary embodiments, the glass composition includes at least 9.5% by weight MgO, including at least 10% by weight, at least 10.5% by weight, at least 11% by weight, at least 11.10% by weight, and at least 11.20% by weight MgO. In some exemplary embodiments, the glass composition includes no greater than 12.5% by weight MgO, such as no greater than 12.0% by weight, no greater than 11.9% by weight, or no greater than 11.8% by weight. In various exemplary embodiments the glass composition comprises an MgO concentration between 10.5% by weight and less than 12.0% by weight.

The glass composition advantageously includes at least 7.0% by weight and no greater than 12% by weight CaO. Including greater than 12% by weight CaO forms a glass with a low elastic modulus. Including less than 7% by weight will either unfavorably increase the liquidus temperature or viscosity depending on with what oxide the CaO is substituted. In some exemplary embodiments, the glass composition includes at least 8.0% by weight CaO, including at least 8.1% by weight and at least 8.2% by weight. In some exemplary embodiments, the glass composition includes no greater than 11.5% by weight CaO, such as no greater than 10.0% by weight, no greater than 9.8% by weight, no greater than 9.5% by weight, and no greater than 9.0% by weight. In various exemplary embodiments the glass composition comprises an CaO concentration between 7.9% by weight and less than 9.0% by weight.

In some exemplary embodiments, the combined amounts of SiO₂, Al₂O₃, MgO, and CaO is at least 98% by weight, or at least 99% by weight, and no greater than 99.5% by weight. In some exemplary embodiments, the combined amounts of SiO₂, Al₂O₃, MgO, and CaO is between 97.5% by weight and less than 99.5% by weight, including between 98.0% by weight and less than 99.0% by weight, and between 98.05% by weight and 98.8% by weight.

The glass composition may include Li₂O in an amount from 0 up to about 2.0% by weight. The presence of Li₂O decreases the fiberizing temperature of the glass composition and increases the elastic modulus of the glass fibers formed therefrom. In some exemplary embodiments, the glass composition includes about 0.2% by weight to about 1.0% by weight Li₂O, including about 0.4% by weight to about 0.8% by weight and about 0.5 to about 0.7% by weight. In some exemplary embodiments, the glass composition includes greater than 0.45% by weight and less than 0.8% by weight Li₂O.

The glass composition may include up to about 2.0% by weight TiO₂. In some exemplary embodiments, the glass composition includes about 0.05% by weight to about 1.5% by weight TiO₂, including about 0.4% by weight to about 1.0% by weight and about 0.5 to about 0.7% by weight.

The glass composition may include up to about 2.0% by weight Fe₂O₃. In some exemplary embodiments, the glass composition includes about 0.05% by weight to about 1.0% by weight Fe₂O₃, including about 0.2% by weight to about 0.8% by weight and about 0.3 to about 0.6% by weight.

In some exemplary embodiments, the glass composition includes less than 2.0% by weight of the alkali metal oxides Na₂O and K₂O, including between 0 and 1.5% by weight. The glass composition may advantageously include both Na₂O and K₂O in an amount greater than 0.01% by weight of each oxide. In some exemplary embodiments, the glass composition includes about 0 to about 1% by weight Na₂O, including about 0.01 to about 0.5% by weight, about 0.03 to about 0.3% by weight, and 0.04 to about 0.1% by weight. In some exemplary embodiments, the glass composition includes about 0 to about 1% by weight K₂O, including about 0.01 to about 0.5% by weight, about 0.03 to about 0.3% by weight, and 0.04 to about 0.2% by weight.

### Optional Additives

In some exemplary embodiments, the glass compositions that form the high-performance glass fibers may further include impurities and/or trace materials without adversely affecting the glasses or the fibers. These impurities may enter the glass as raw material impurities or may be products formed by the chemical reaction of the molten glass with furnace components. Non-limiting examples of trace materials include zinc, strontium, barium, and combinations thereof. The trace materials may be present in their oxide forms and may further include fluorine and/or chlorine. In some exemplary embodiments, the inventive glass compositions contain less than 1.0% by weight, including less than 0.5% by weight, less than 0.2% by weight, and less than 0.1% by weight of each of BaO, SrO, ZnO, ZrO₂, P₂O₅, and SO₃. Particularly, the glass composition may include less than about 5.0% by weight of BaO, SrO, ZnO, ZrO₂, P₂O₅, and/or SO₃ combined, wherein each of BaO, SrO, ZnO, ZrO₂, P₂O₅, and SO₃ if present at all, is present in an amount of less than 1.0% by weight.

In some exemplary embodiments, the glass compositions that form the high-performance glass fibers include less than 2.0 wt. % of the following modifying components (collectively): CeO₂, Li₂O, Fe2O₃, TiO₂, WO₃, and Bi₂O₃. In some exemplary embodiments, the glass compositions include less than 1.5 wt. % of the modifying components.

In some exemplary embodiments, the glass compositions that form the high-performance glass fibers include less than 1.0% by weight of the rare earth oxides: Y₂O₃, Ga₂O₃, Sm₂O₃, Nd₂O₃, La₂O₃, Ce₂O₃, and Sc₂O₃ (“R₂O₃”) and Ta₂O₅, Nb₂O₅, or V₂O₅ (“R₂O₅”), including between 0 and 0.9% by weight, or between 0 and 0.5% by weight. In some exemplary embodiments, the glass composition is free of rare earth oxides.

As used herein, the terms “weight percent,” “% by weight,” “wt. %,” and “percent by weight” may be used interchangeably and are meant to denote the weight percent (or percent by weight) based on the total composition.

### Resin Binder

The high-performance input glass fibers are held together by a resin binder (also referred to as a matrix resin) that when cured (as described below) fixes the fibers relative to one another and forms the high modulus composite. In some exemplary embodiments, the resin binder comprises one or more of polyester (PE) resins, vinylester (VE) resins, acrylic resins, urethane resins, and epoxy (EP) resins, which are commonly used matrix resins or binders for forming polymer composites. In some exemplary embodiments, the resin binder comprises one of vinyl ester and epoxy resin. Because the composites are often used as a reinforcement in harsh or otherwise corrosive environments, such as near seawater, selection of a resin that can survive in such an environment is an important design consideration.

It has been discovered that proper formulation or modification of a vinyl ester resin is important. For example, small additions of urethane or novolac or interpenetrating network of acrylic or other reactive monomer modification for styrene could further enhance corrosion resistance. High corrosion resistance may be further improved by removing resin from the resin-rich surface of the bar and/or applying a hydrated inhibitor, such as acrylate, vinyl chloride, octyl silane, and/or silylated polyazamide. Such additives work with the concrete, for example, as a barrier for further corrosion resistance of the composite and interface with the concrete.

Other additives may also further be included, such as, for example, caprylic acid salts of n,ndimethyl ethanolamine or morpholine related amines which are effective surface corrosion inhibitors that could be applied as a coating to the rebar to provide an improved concrete bonding interface. Other migrating agents could be applied as well to work during concrete crack initiation at the rebar interface to block further corrosion. Additionally, certain glass fiber interface sizing components like one or more of an acrylic, a salt, sodium or ammonium tetrafluoroborate, or crosslinker pentaerythritol or itaconic acid, or highly crosslinking silane/silanol such as octyl silane forms a stable passivating layer or could work with the glass poly-condensed silicate surface to block or inhibit water and alkali ingression as an interfacial alteration layer. The glass/alteration layer interphase is more efficient than the glass itself in preventing water ingress. Water mobility in pristine and altered glass is strongly affected by chemical interactions with the solid phase. Under silica saturation conditions, the reorganized alteration layer achieves equilibrium with the bulk and pore solutions, and the residual corrosion rate dramatically diminishes due to transport-limiting effects near the glass surface. Ideal conditions for a stable passivating layer are typically less than 90° C. and 7<pH<9.5, silica-saturated solution, optimal for the concrete hydrate at the adhesive interface with the rebar.

Additional additives may include multi-functional fillers for various purposes, such as color and surface aesthetics, adhesion/cohesion characteristics for strength and toughness, reduced shrinkage, UV resistance, corrosion resistance, and consolidation uniformity with consistent part tolerances. Exemplary fillers may include carbon black, iron black, aluminum trihydrate, calcium carbonate, metal salts of a fatty acid, including zinc and calcium stearate, and clay, such as kaolin clay. The particular physical and functional properties of the filler, as well as the amount of filler in a composite part may be tuned to achieve the desired attribute or functional purpose.

The filler may be included in the high modulus composite part in an amount between about 0 to 20 phr, including between about 3 and about 16 phr, between about 5 and about 13 phr, and between about 6 and about 10 phr. In some exemplary embodiments, the filler is included in the high modulus composite part in an amount between 10 and 16 phr.

In some exemplary embodiments, including about 5-10 phr of clay filler in a high modulus vinyl ester composite part with a glass content of 71% by volume improved the consolidation uniformity and reduced shrinkage, while maintaining a tensile strength, according to ASTM-D7205, of greater than 1,000 MPa, and in some cases, greater than 1,200 MPa.

### Pultrusion Process

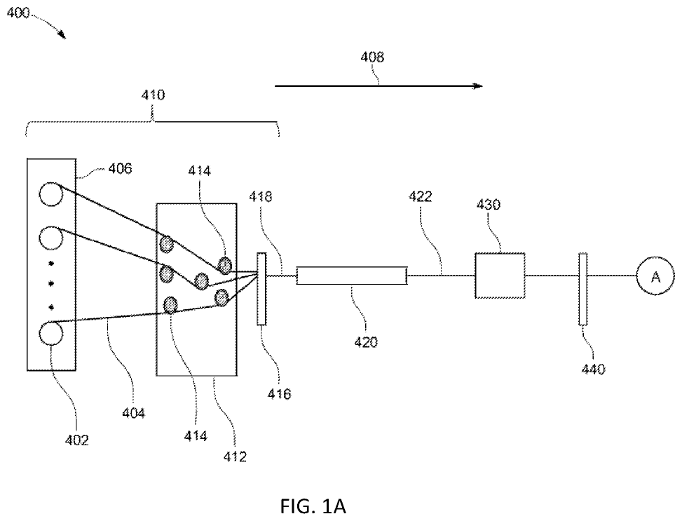

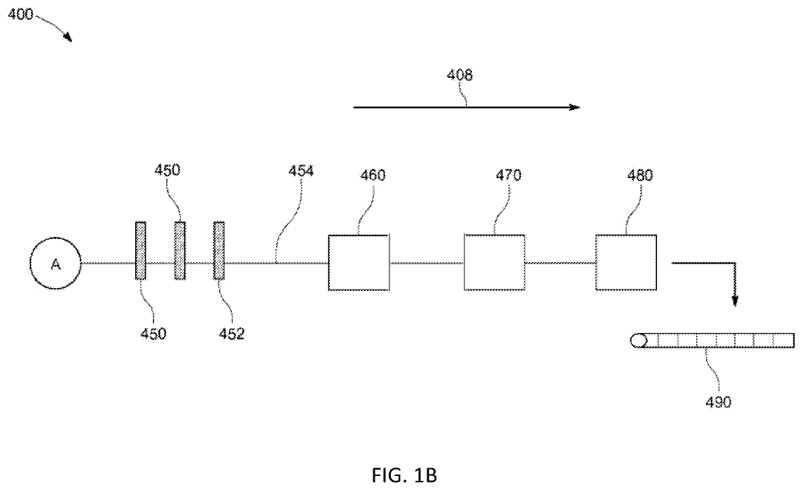

The high modulus composite of the present invention is formed by a pultrusion process. The pultrusion process is carried out by a pultrusion line, system, or the like. In some exemplary embodiments, the pultrusion process is used to form composite rebar. As shown in FIGS. 1A and 1B, a pultrusion line 400, according to an exemplary embodiment, can be used to form composite rebar 490. The pultrusion line 400 includes an infeed module 410, a resin bath 420, an optional in-line winder 430, one or more pre-formers 440, one or more dies 450, a control station 460, a pulling section 470, and a cutting section 480. As further described below, a surface treatment station (not shown) could also be provided. The surface treatment could occur before and/or after the pultruded rods are cut at the cutting section 480.

The pultrusion line 400 ensures that the input material (e.g., glass fiber) and related processing thereof is carefully controlled in fiber feed, resin formulation, resin impregnation, fiber architecture, alignment through the pre-former, drying and heating, wetting, wet-through, consolidation, and curing to form a continuous rod.

The infeed module 410 organizes the input material, for example, a collection of rovings 402 of glass fibers 404 (e.g., Type 30® rovings available from Owens Coming of Toledo, Ohio) situated on a creel 406 or the like, for the pultrusion process. The rovings 402 can be single-end rovings and/or multi-end rovings.

In one exemplary embodiment of the infeed module 410, as shown in FIGS. 1A and 1B, multiple rovings 402 are used depending on the desired rod diameter. An end of each roving 402 is fed toward the resin bath 420 in a pultrusion direction indicated by the arrow 408.

In this embodiment, the fibers 404 are fed through a cage 412 or other structure, such that the fibers 404 engage bars 414 disposed therein. The bars 414 impart an initial tension to the fibers 404 as they are drawn through the cage 412. The cage 412 also acts to begin positioning ends of the fibers 404 closer to one another prior to the ends being fed through a guide 416.

The guide 416 includes a plurality of apertures. An end of each of the fibers 404 is fed through one of the apertures in the guide 416. In this manner, the fibers 404 are positioned closer to one another and relatively parallel to one another, as the fibers 404 are drawn in the processing direction 408. Thus, as the fibers 404 exit the guide 416, they have begun to form a rope-like member 418 (hereinafter, the “rope”).

The rope 418 is then drawn through the resin bath 420, such that a resin in the resin bath 420 surrounds the rope 418 and penetrates the spaces between the fibers 404 forming the rope 418. The rope 418 leaves the resin bath 420 as an impregnated rope 422.

The resin bath 420 contains a vinyl ester or modified thermosetting resin with elongation to break greater than 4%. It is important that the resin has a low cure shrinkage (e.g., 3-7% depending on formulation) without significant residual stresses causing voids, crazing, or splitting leading to premature failure from the load environment or durability issues. In one exemplary embodiment the resin composition is a modified resin based on the Ashland 1398 vinyl ester resin matrix (supplied by Ashland, Inc. of Covington, Ky.) or Interplastic 692 or 433 (supplied by Interplastic Corporation of St. Paul, Minn.), having its crosslink density set by ratio of added styrene monomer for free radical autocatalytic cure to achieve a Tg within the range of 100° C. to 130° C. Acrylic, novolac, or dicyclopentadiene (DCPD) monomer substitution of a portion (e.g., 10% to 30%) of the styrene may improve toughness, moisture durability, and satisfy fire-smoke-toxicity (FST) standards. These resin composition design choices should be balanced against their cost and influence on Tg, modulus, and crazing/cracking in rod cross-section greater than 0.8 mm from too high a cure rate.

| Vinylester Resin FFU | Test Standard | Property |
|---|---|---|
| Durability - no polyester | ASTM D7957 5.2 | Meet physical |
| | | and durability |
| | | recquirements |
| Glass Transition (or HDT) | ASTM E1356 | T_{g} > 120° C. |
| Tensile Elongation or Break | ASTM D638 | >4.5% |
| Tensile Modulus | ASTM D638 | >3,200 MPa |
| Volume Shrinkage | | <7% |

As noted above, the glass fibers 404 from the infeed module 410 pass through the resin bath 420 such that the glass fibers 404 are coated with the resin (i.e., wetting) and spaces between adjacent fibers are adequately filled with the resin (i.e., wet-through or impregnation). More specifically, the pultrusion line 400 uses multi-stage pre-forming where the glass fibers 404 are aligned vertically and horizontally for positioning in the pre-former(s) 440 after they pass through the resin bath 420. In this manner, each discrete stage of the pultrusion line 400 consolidates the respective fiber bundles into 70% or greater, 80% or greater, or 83% or greater glass content by weight or 68% or greater by volume, as the fibers 404 pass through the die(s) 450.

The pre-former(s) 440 aid in the positioning and aligning of the input material including the resin. The pre-former(s) 440 also aid in packing the fibers together in a manner that avoids bunching, entanglement, and other undesirable problems with the input material.

The use of multi-stage pre-forming also enables selective placement of different fiber types (e.g., glass and carbon, combinations of different glass types, combinations of different fiber diameters), so as to produce a hybrid rod to improve elastic modulus or other attributes. The use of different fiber diameters in the input material can also facilitate achieving the increased content of the input material.

An in-line winder 430, such as one or more driven rolls, can be used in the pultrusion line 400 as a tension adjusting means. The winder 430 could be used, for example, if more pulling force is needed early in the pultrusion process (e.g., to draw the glass fibers 404 through the resin bath 420). Additionally, the ability to adjust the tension on the glass fibers 404 can facilitate the consolidation/packing of the glass fibers 404 before they enter the pre-former(s) 440.

The pultrusion line 400 employs pre-forming, pre-heating, and pre-wetting of the continuous collimated roving for consolidation to greater than 85% by weight glass content with high alignment (i.e., less than 5 degrees off orientation uniformly through the cross-section).

In some exemplary embodiments, one or more stripper dies 450 are used prior to the pultrusion die(s) 452. In some exemplary embodiments, the stripper die(s) 450 and the pultrusion die(s) 452 are the same set of dies. When multiple stripper dies 450 are used, an aperture in each stripper die 450 will typically be smaller than an aperture in the preceding stripper die 450. The stripper dies 450 remove excess resin from the impregnated fibers and further consolidate the fibers 404 as the rod 454 is being formed.

The pre-heating of the glass drives off residual moisture and enables reduced resin viscosity at the glass surface to improve wetting and wet-through. Any suitable means of applying heat to the glass can be used. Such pre-heating can occur at multiple locations along the pultrusion line 400.

The pre-wetting of the glass fibers is facilitated by direct heating of the resin or otherwise controlling the viscosity of the resin in the immersion bath 420 or as applied by position in the pre-formers 440 to better achieve resin wetting for more dense consolidation by confinement and/or tension before gelation of the vinyl ester resin. Alternatively, the heating can be accomplished through indirect (e.g., radio-frequency) heating, which can allow more uniform inside-out heating. Different glass tex and filament diameter combinations can be used to further improve the uniform glass packing, thereby enabling higher glass fiber volume.

Once entering the die(s) 450,452, which is the final consolidation point, heat from the die(s) 450 and/or 452 crosslinks the thermosetting resin, resulting in an exotherm within the consolidated fibers 422 to form a rod-like member 454 (herein, the “rod”). In some exemplary embodiments, a helical wrapping (e.g., of a glass fiber) is applied to the rod 454 to maintain the consolidation and placement of the fibers 404 therein.

The pultrusion line 400 will often include a control station 460, either as part of the pultrusion line 400 or situated in proximity (e.g., on-site) thereto. The control station 460, which can be a distributed control system (DCS), allows for computerized and/or manual control and management of the pultrusion line 400 and related process variables and conditions.

The rod 454 exits the pultrusion die(s) 452 and advances towards the puller system 470. The rod 454 is cooling as it reaches the puller system 470 such that it does not deform in the puller contact points. The pulling section 470 aids in exerting the pulling force required by the pultrusion process, i.e., to maintain the necessary tension on the rod 454 while it is being formed.

Finally, the rod 454 advances to the cutting section 480 where it is cut to length and collected for further processing, such as a surface treatment operation. The rod 454 can be cut to any suitable length, with the length often being determined by the intended application. In some exemplary embodiments the rod 454 is cut to a length of 10 ft. to 75 ft. In some exemplary embodiments the rod 454 is cut to a length of 20 ft. to 60 ft. Once cut, with or without any further treatment thereof, the rod 454 is considered the composite rebar 490.

Thus, the pultrusion line 400 uses pre-forming, pre-heating, and pre-wetting of continuous collimated roving for consolidation to greater than 85% by weight glass content with high alignment less than 5 degrees off orientation uniformly through the cross-section, in combination with a high-performance glass fiber to achieve a high modulus composite having an increased modulus of at least 60 GPa.

In some exemplary embodiments, at least a portion of the rod cross-section could be hollow or foam cored instead of solid, such as by use of suitable die constructions and/or configurations or other processing techniques.

### High Modulus Composite Part

The high modulus composites may be formed comprising fiber reinforcements at various fiber weight fractions (“FWF”). Although the FWF may vary anywhere between greater than 1% to about 90%, certain exemplary embodiments comprise a FWF of at least 70%, including at least 72%, at least 75%, at least 77%, and at least 80%. In any of the exemplary embodiments, the high modulus composite may have a FWF of 75% to 90%, including between 77% and 88%, and between 80% and 86%.

The high modulus composites formed in accordance with the present inventive concepts comprise improved physical properties and corrosion resistance compared to reinforced composites formed using conventional ECR-type glass fibers. As mentioned above, the high modulus composite part comprises an improved elastic modulus of at least 60 GPa, including at least 64 GPa, at least 65 GPa, at least 66 GPa, and at least 68 GPa. In some exemplary embodiments, the high modulus composite part comprises an elastic modulus of 60 GPa to 75 GPa, including between 64 GPa and 73 GPa, and between 65 GPa and 70 GPa. The elastic modulus of the composite part is measured in accordance with ASTM D7205.

In some exemplary embodiments, the high modulus composites formed in accordance with the present inventive concepts comprise a flexural modulus of at least 50 GPa, including at least 52 GPa, at least 55 GPa, and at least 56 GPa. The high modulus composites formed in accordance with the present inventive concepts comprise an improved flexural strength of at least 1220 MPa, including at least 1250 MPa, at least 1285 MPa, at least 1300 MPa, at least 1350 MPa, at least 1400 MPa, at least 1450 MPa, at least 1500 MPa, and at least 1550 MPa. Both flexural modulus and flexural strength are measured in accordance with ASTM D790.

In some exemplary embodiments, the high modulus composites formed in accordance with the present inventive concepts comprise a tensile modulus of at least 50 GPa, including at least 62 GPa, at least 65 GPa, at least 67 GPa, and at least 70 GPa. In some exemplary embodiments, the high modulus composites have a tensile modulus of about 60 to about 75 GPa. The tensile modulus of the composite part is measured in accordance with ASTM D7205.

In some exemplary embodiments, the high modulus composites formed in accordance with the present inventive concepts comprise a high corrosion resistance, which extends the life of the composite part.

### EXAMPLES

It will be appreciated that the scope of the general inventive concepts is not intended to be limited to the particular exemplary embodiments shown and described herein. From the disclosure given, those skilled in the art will not only understand the general inventive concepts and their attendant advantages but will also find apparent various changes and modifications to the methods and systems disclosed. It is sought, therefore, to cover all such changes and modifications as fall within the spirit and scope of the general inventive concepts, as described and claimed herein, and any equivalents thereof.

### Example 1

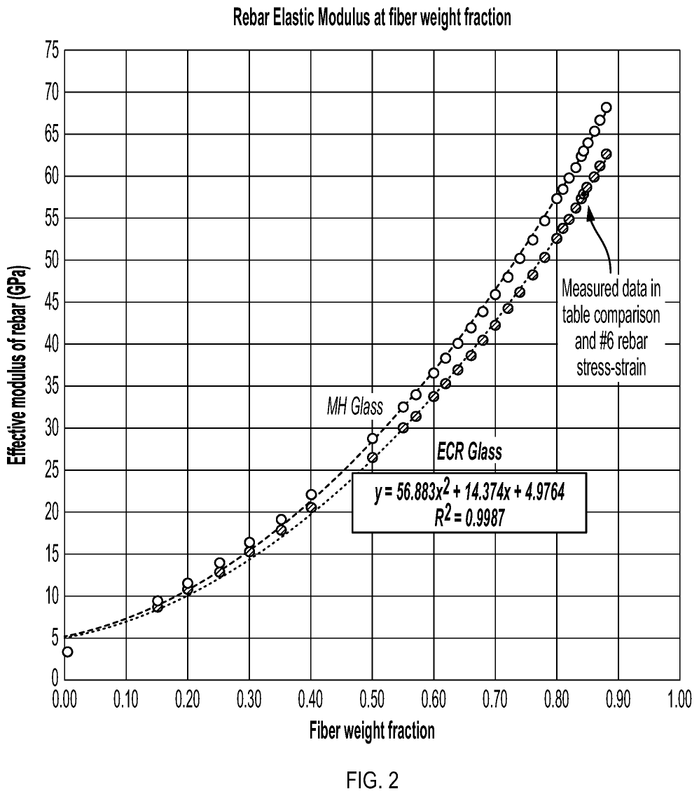

Exemplary fiber-reinforced pultruded rebar parts were prepared comprising fiber reinforcements at various fiber weight fractions (“FWF”). Samples were prepared with both high-performance glass having an elastic modulus of 89.5 GPa (“HP glass”) and conventional E-CR-glass having an elastic modulus of 82 GPa. FIG. 2 illustrates the elastic modulus of the rebar samples at the varying fiber loading levels. As illustrated, the rebar samples comprising HP glass achieve a higher elastic modulus than those comprising E-CR-glass, at the same loading levels. For instance, E-CR-glass reinforced rebar at 0.843 fiber weight fraction achieved an elastic modulus of 64.6 GPa according to ASTM-D7205 (#6 Rebar with cross-sectional area of 283.9 mm²), while HP glass reinforced rebar achieved an elastic modulus of 70.4 GPa at the same fiber loading level.

### Example 2

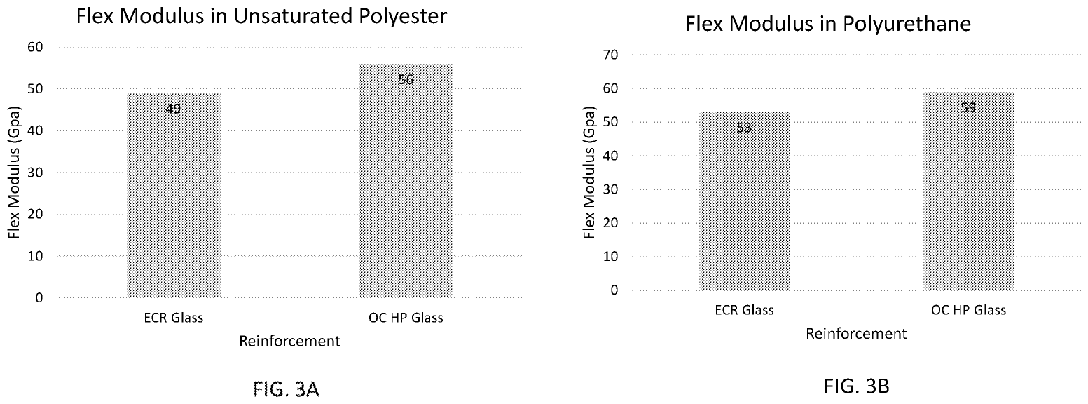

Exemplary fiber-reinforced pultruded flat plates were prepared comprising both: 1) HP glass fibers and 2) conventional E-CR-glass fibers. The pultruded flat plates comprised unidirectional fibers at a loading level of 80% FWF. Two different resins were used in the tests, polyester and polyurethane. The pultruded parts were then tested for performance properties, including flex modulus and flex strength, in accordance with ASTM-D790; tensile modulus in accordance with ASTM D7205, and interlaminar shear strength (“ILSS”) in accordance with ASTM D2344. The results of the tests are illustrated in FIGS. 3-6.

FIGS. 3A and 3B illustrate the flex modulus of pultruded flat plates comprising E-CR unidirectional fibers, compared to pultruded flat plates comprising HP fibers, in both unsaturated polyester and polyurethane resin. As illustrated, HP-reinforced plates demonstrate a flex modulus increase of 14% in polyester resin and 10% in polyurethane resin, compared to E-CR-reinforced plates. The exemplary HP-reinforced plates achieved a flex modulus of 56 GPa in unsaturated polyester and 59 GPa in polyurethane.

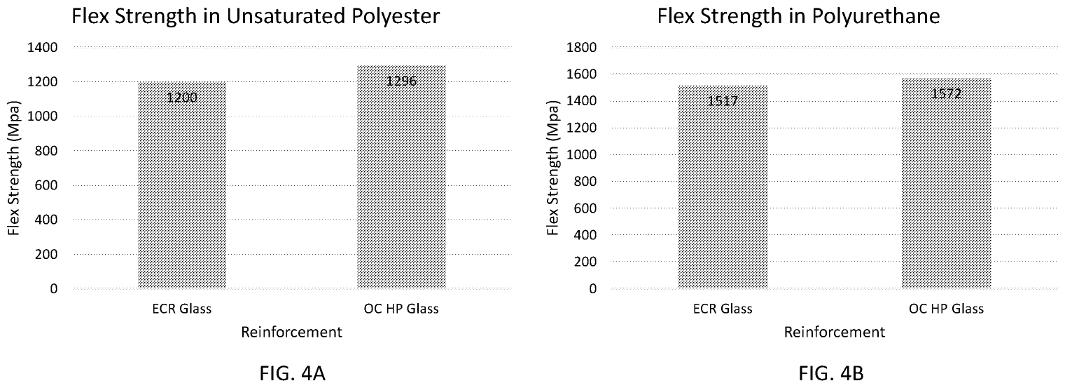

FIGS. 4A and 4B illustrate the flex strength of pultruded flat plates comprising E-CR unidirectional fibers, compared to pultruded flat plates comprising HP fibers, in both unsaturated polyester and polyurethane resin. As illustrated, HP-reinforced plates demonstrate a flex strength increase of 8% in polyester resin and 4% in polyurethane resin, compared to E-CR-reinforced plates. The exemplary HP-reinforced plates achieved a flex strength of 1296 MPa in unsaturated polyester and 1572 MPa in polyurethane.

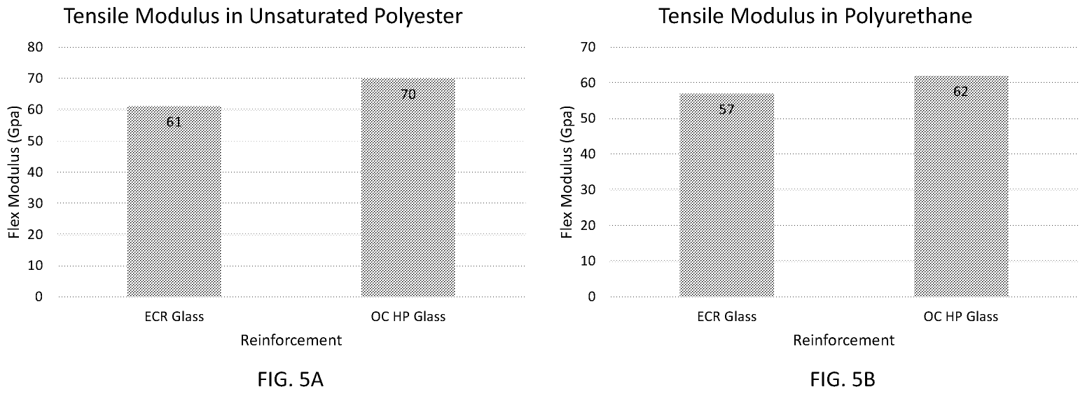

FIGS. 5A and 5B illustrate the tensile modulus of pultruded flat plates comprising E-CR unidirectional fibers, compared to pultruded flat plates comprising HP fibers, in both unsaturated polyester and polyurethane resin. As illustrated, HP-reinforced plates demonstrate a tensile modulus increase of 13% in polyester resin and 8% in polyurethane resin, compared to E-CR-reinforced plates. The exemplary HP-reinforced plates achieved a tensile modulus of 70 GPa in unsaturated polyester and 62 GPa in polyurethane.

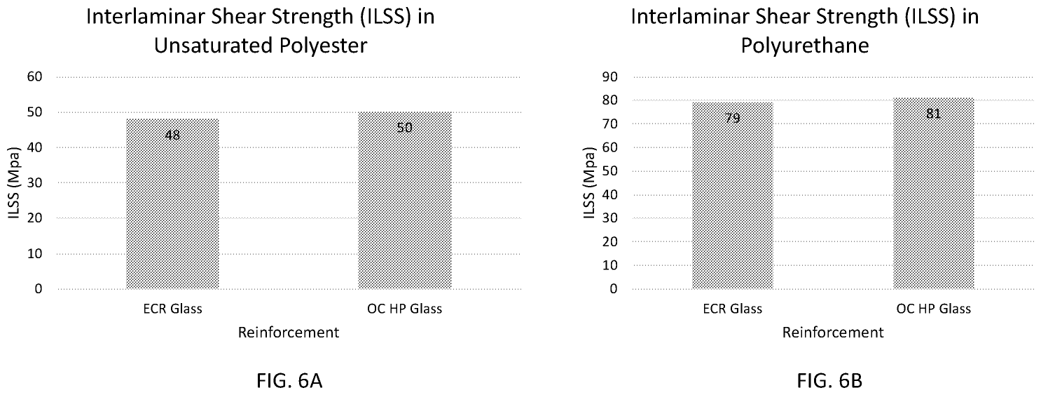

FIGS. 6A and 6B illustrate the interlaminar shear strength (ILSS) of pultruded flat plates comprising E-CR unidirectional fibers, compared to pultruded flat plates comprising HP fibers, in both unsaturated polyester and polyurethane resin. As ILSS is primarily resin dependent, the results indicate compatibility at the glass/resin interface. The exemplary HP-reinforced plates achieved an ILSS of 50 MPa in unsaturated polyester and 81 MPa in polyurethane, which is consistent with (and in fact slightly improved over) those formed using E-CR-glass.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A high modulus composite part comprising:
a polymer resin; and
a plurality of high-performance unidirectional glass fibers having an elastic modulus of at least 89 GPa and a tensile strength of at least 4,000 MPa, according to ASTM D2343-09, said composite part comprising a fiber weight fraction (FWF) of no more than 88% and an elastic modulus of at least 60 GPa, according to ASTM D7205.

2. A high modulus composite part according to claim 1, wherein said polymer resin is selected from the group consisting of urethane, acrylic, polyester, vinyl ester, and epoxy.

3. A high modulus composite part according to claim 1, wherein said high modulus composite part comprises rebar, railings, poles, pipes, cross-arms, infrastructure, cables, telecom applications, ladder rails.

4. The high modulus composite part according to any one of claims 1, wherein the high-performance glass fibers are formed from a composition that is substantially free of B₂O₃ and fluorine.

5. The high modulus composite part according to claim 1, wherein the high-performance glass fibers have a tensile strength of at least 4,800 MPa according to ASTM D2343-09.

6. The high modulus composite part according to claim 1, wherein the high-performance glass fibers have an elastic modulus of at least 90 GPa.

7. The high modulus composite part according to claim 1, wherein the high-performance glass fibers have a specific modulus from about 32.0 MJ/kg to about 37.0 MJ/kg.

8. The high modulus composite part according to claim 1, wherein the high modulus composite part comprises an elastic modulus of at least 60 GPa, according to ASTM D7205.

9. The high modulus composite part according to claim 1, wherein the high modulus composite part comprises a flexural modulus of at least 50 GPa, according to ASTM D790.

10. The high modulus composite part according to claim 1, wherein the high modulus composite part comprises a tensile modulus of at least 50 GPa, according to ASTM D7205.

11. A process for forming a high modulus composite part comprising:
drawing a bundle of high-performance unidirectional glass fibers from an input source, said fibers comprising an elastic modulus of at least 89 GPa and a tensile strength of at least 4,500 MPa, according to ASTM D2343-09;
passing the bundle through a bath of polymer resin material, forming resin-coated bundle;
pulling the resin-coated bundle through a shaping die; and
curing the resin-coated bundle, forming a high modulus composite part comprising a fiber weight fraction (FWF) of no more than 88% and an elastic modulus of at least 60 GPa, according to ASTM D7205.

12. The process of claim 11, wherein said polymer resin is selected from the group consisting of polyester, vinyl ester, and epoxy.

13. The process of claim 11, wherein said high modulus composite part comprises rebar, railings, poles, pipes, cross-arms, infrastructure, cables, telecom applications, ladder rails.

14. The process of claim 11, wherein the high-performance glass fibers are formed from a composition that is substantially free of B₂O₃ and fluorine.

15. The process of claim 11, wherein the high-performance glass fibers have a tensile strength of at least 4,800 MPa.

16. The process of claim 11, wherein the high-performance glass fibers have an elastic modulus of at least 90 GPa.

17. The process of claim 11, wherein the high-performance glass fibers have a specific modulus from about 32.0 MJ/kg to about 37.0 MJ/kg.

18. The process of claim 11, wherein the high modulus composite part comprises an elastic modulus of at least 60 GPa, according to ASTM D7205.

19. The process of claim 11, wherein the high modulus composite part comprises a flexural modulus of at least 50 GPa, according to ASTM D790.

20. The process of claim 11, wherein the high modulus composite part comprises a tensile modulus of at least 50 GPa, according to ASTM D7205.
